(19) United States
(12) Patent Application Publication
(10) Pub. No.: US 2008/0219481 A1
(43) Pub. Date: Sep. 11, 2008

(54) Loudspeaker Having a Movable Cone Body

(75) Inventor: Jozef Baeten, Eindhoven (NL)

Correspondence Address: SHEEHAN PHINNEY BASS & GREEN, PA;c/o PETER NIEVES, 1000 ELM STREET, MANCHESTER, NH, 03105-3701, US

(73) Assignee: PSS BELGIUM N.V., Dendermonde (BE)

(21) Appl. No.: 11/813,390

(22) PCT Filed: Jan. 4, 2006
(86) PCT No.: PCT/IB2006/050027

§ 371 Date: Aug. 2, 2007

(30) Foreign Application Priority Data
Jan. 6, 2005 (EP) 05100049.5

(51) Int. Cl. H04R 1/00

(52) U.S. Cl. 381/150

(57) ABSTRACT

A loudspeaker (1) has a chassis (2). A movable cone body (3), a resilient suspension for guiding the movable cone body (3) with respect to the chassis (2) along a translation axis T, and an electric actuator (4) for driving the movable cone body (3) along the translation axis T, and a centering diaphragm (8). The centering diaphragm (8) and the movable cone body (3) are interconnected, at a distance D1 from the actuator support (7), by a bridging element (10), the bridging element (10) having a number of separate contact areas (10a) with the movable cone body (3) around the actuator support (7).

The invention relates to a loudspeaker provided with a chassis, a movable cone body, a resilient suspension for guiding the movable cone body with respect to the chassis along a translation axis, and an electric actuator for driving the movable body along the translation axis, an actuator support and a centering diaphragm.

Loudspeakers of such a type are generally known; e.g. PCT Patent Application WO 96/14722 discloses such a speaker. This known loudspeaker has a chassis, a cone shaped membrane and an electromagnetic driving unit. The membrane is formed by a conical body and has an outer circumferential edge and an inner circumferential edge. The driving unit is provided with a stationary part and a movable part. The stationary part includes a permanent magnet and a magnetic yoke and is secured to the frame. The movable part includes a voice coil and a cylindrical coil support. At its outer circumferential edge, the membrane is connected to the chassis by means of a flexible suspension and, at its inner circumferential edge, it is adhered to the coil support, which in its turn is connected to the frame by means of a centering diaphragm, which is sometimes also called a spider.

The conical membrane of the known loudspeaker has a certain height in order to obtain sufficient stiffness. The membrane should have a certain minimal stiffness in order to be able to move like a piston.

The current trend in the audio and loudspeaker markets is the implementation of flat and light weight loudspeakers.

A good loudspeaker should be effective over a relatively large range of frequency and in a predictable manner. Preferably the efficiency of the loudspeaker should be more or less constant over its working range, i.e. the range of frequency at which the loudspeaker effectively emits sounds, and the working range is large. Sudden drop-offs of efficiency give raise to drastic changes in pressure response and phase shifts, which results amongst others into bad placement of the music when stereo sound is produced.

The design in accordance with the prior art has only a limited range of usable frequencies, especially when attempts are made to make the loudspeakers flatter.

For this reason, there arise problems relating to the speaker's performance in regards to the useful frequency range of the loudspeaker.

Making a classical electrodynamic loudspeaker more flat poses a dilemma to the designer, downscaling the loudspeaker, i.e. making all dimensions of the loudspeaker smaller does reduce the depth of the loudspeaker, but equally reduces the power, since the diameter of the loudspeaker is reduced. Making the conventional loudspeaker flatter while maintaining the same diameter, reduces the working range, i.e. the efficiency in the upper part of the frequency range (usually the 5 kHz to 10 kHz range) is drastically reduced.

It is an object of the invention to overcome the dilemma, i.e. to enable to flatten a loudspeaker of the type described in the opening paragraph in comparison to conventional loudspeakers, while substantially retaining the power and frequency range of the conventional loudspeaker.

This object is achieved with the loudspeaker according to the invention, which is provided with a chassis, a movable cone body, a resilient suspension for guiding the movable cone body with respect to the chassis along a translation axis, and an electric actuator for driving the movable cone body along the translation axis, and an actuator support and a centering diaphragm, wherein the centering diaphragm and the movable cone body are interconnected, at a distance from the actuator support, by a bridging element, the bridging element have a number of separate contact areas with the movable cone body around the actuator support.

Therefore, in the loudspeaker according to the invention the centering diaphragm is not directly connected to the actuator support, but a bridging element is provided which provides a mechanical bridging between centering diaphragm and the movable cone body. The bridging element has a number of separate contact areas with the movable cone body around the actuator support.

An embodiment of a centering diaphragm is often called a ‘spider’.

The invention is amongst others based on the following insights:

In the lowest frequency domain the driving force coming from the actuator drives the cone body like a pure piston. Into the higher frequency range the acceleration of the driving force becomes so high that the total cone body can no longer follow the accelerations of the actuator. As a result, a decrease in effective radiating surface of the cone body and thus of the loudspeaker occurs. This effect is then leading to a decrease in the corresponding moving mass. Increasing the frequency even more will lead to a further decrease in the effective radiating surface, and eventually at very high frequencies the only part left radiating energy is the dust cap, which is conventionally placed on the actuator. This effect occurs in the known design. Making loudspeakers flatter in the conventional design aggravates the problem, thus effectively reducing the effective frequency range of the loudspeaker.

In the present invention a bridging element is provided between the centering diaphragm and the cone body. The bridging element acts as a mechanical bridge between the centering diaphragm and the cone body.

The bridging element is connected to the cone body at separate areas around the actuator support, at a distance from the actuator support.

At low frequencies the cone body is actuated as a pure piston, at higher frequencies, the effective areas decreases. By the use bridging element the loudspeaker is able to provide substantially the same power and frequency range as a conventional loudspeaker, i.e. to operate as good as a classical construction even though it design allows a much flatter construction.

Preferably the number of contact areas is 3 to 8, more preferably 4 to 6, most preferably 4.

A higher number of contact areas (higher than 8) would provide a mechanical coupling between the cone body and the diaphragm which would have a considerable stiffening effect on the cone body; A full contact ring significantly reduces the frequency response in the higher frequency range, typically in the range 5-10 Khz. The ensuing acoustical phase shifts will also make it difficult to combine the unit with other units in for example multiple way systems.

Two contact areas would provide only a limited positive effect.

The distance between the contact areas and the actuator support is preferably between ⅕ and ½ of the radial extent of the cone body, more preferably between ⅕ and ⅖, most preferably between 0.25 and 0.35. The radial extent of the cone body is the extent of the cone body between the actuator support and an outer suspension of the cone body.

The effect of the bridging element is to begin to be noticeable at higher frequencies to improve the behavior of the loudspeaker at said higher frequencies. At lower frequencies, there is no need for the effect of the bridging element; in fact it is slightly detrimental. The further the contact points are from the actuator body, the lower the frequency is at which the effect of the bridging element becomes noticeable. The less the distance to the actuator support is, the less the effect at higher frequencies. In the indicated range, the positive effect is very noticeable and favorable, while the negative effect at lower frequency is small to negligible.

Preferably the bridging element is a single piece connected via a ring with the spider. The bridging element could be made of a number of sub-elements, each forming a connection between the cone body and the spider or diaphragm but using a ring-shaped part provides stiffness to the diaphragm at the contact point.

It is to be noted in relation to the claims that various combinations of characteristic features defined in the claims are possible.

The above-mentioned and other aspects of the invention are apparent from and will be elucidated, by way of non-limitative examples, with reference to the embodiment described hereinafter.

In the drawings:

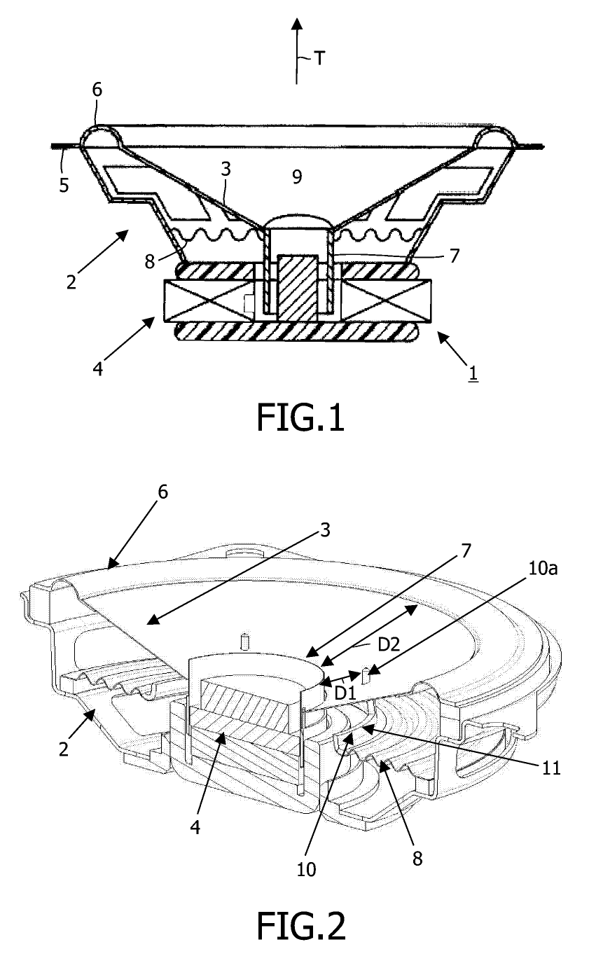

FIG. 1 shows an example of a loud speaker described in the prior art,

FIG. 2 shows an embodiment of the flatter loudspeaker according to the invention in a diagrammic cross-section, and

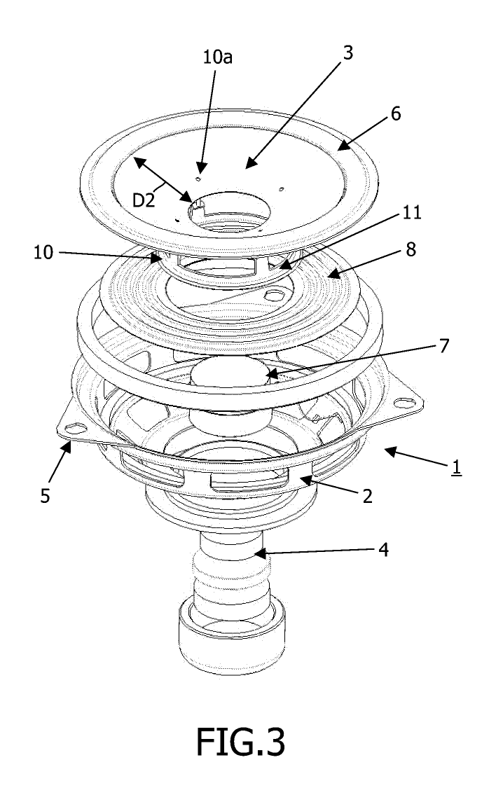

FIG. 3 is a perspective elerational view of the loudspeaker of FIG. 1 in an exploded view.

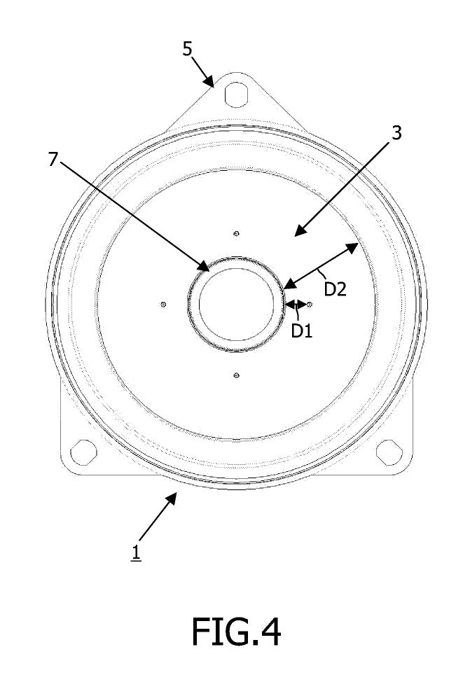

FIG. 4 is a top view of the loudspeaker of FIG. 2.

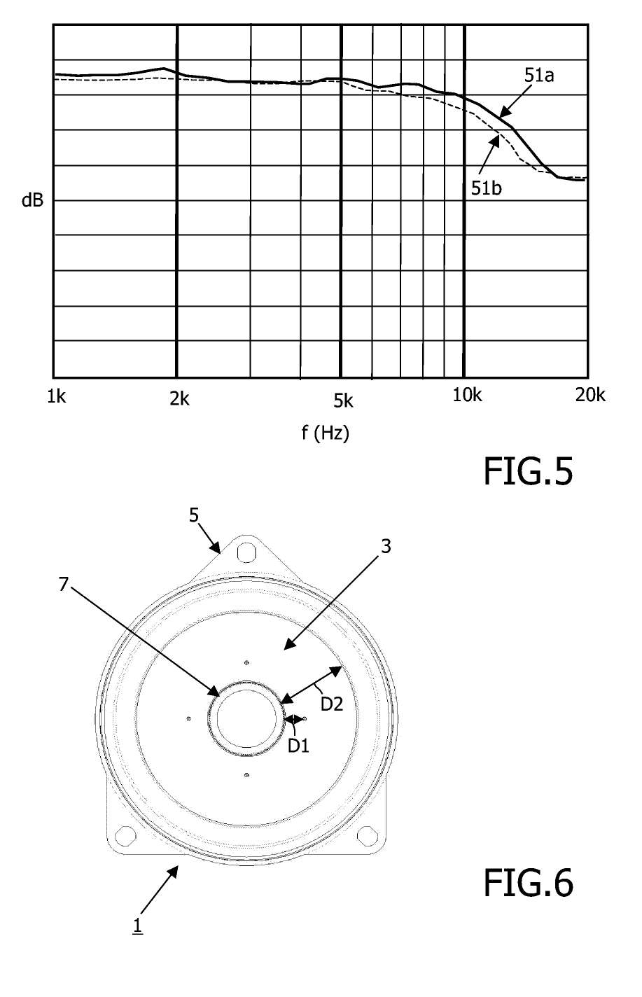

FIG. 5 illustrates in the form of a graph the effect of the invention, wherein line 51a exemplifies a conventional loudspeaker en line 51b exemplifies a loudspeaker in accordance with the invention, but of a flatter construction with a comparable frequency response.

FIG. 6 illustrates an embodiment of a loudspeaker in accordance with the invention of an oval design.

The prior art electrodynamic loudspeaker 1 shown in FIG. 1, comprises a chassis 2, a movable cone body 3 and an electromagnetic actuator 4 for actuating the cone body to make it move in a translational direction T. For forming a loudspeaker unit according to the invention, the loudspeaker may be accommodated in a housing. To this end, the chassis 2 may be fixed by means of fixing means 5 in an appropriate opening in a wall of such a housing. In FIG. 1, the housing is shown diagrammatically by means of a wall section 1 in broken lines.

The movable body 3 is connected via a resilient element 6 to the chassis 2. The resilient element 6 may have a roll structure known per se and is formed, for example, from a bent rubber or foam annular strip. On its outer circumference, the resilient element is secured, for example glued, to the chassis 2 and on its inner circumference to an outer circumferential edge of the cone-shaped body 3. The cone shaped body 3 is connected to an actuator support or housing 7. A diaphragm 8 extends between the chassis 2 and the actuator housing 7 and is connected to both. This diaphragm 8, also called a spider, ensures that the movable body 3 can perform well-defined translation movements along direction T with respect to the chassis 2. A dust cap 9 is conventionally provided on the actuator housing 7. The loudspeaker thus comprises a resilient suspension for suspending the movable body 3 from the chassis 2 and for guiding the movable body along a translation axis T. The suspension includes a resilient element 6 between an outer circumference of the cone body 3 and the chassis 2, and diaphragm 8 between the chassis 2 and the actuator support 7.

Although the known design often operates satisfactorily, there remains a need for improvement especially making these loudspeakers a lot flatter.

In particular it is desired to increase the effective frequency range and to provide a constant behavior over the effective frequency range, without reducing power.

The prior art design has, the inventors have realized, a number of shortcomings, having a negative effect on the effective frequency range and the behavior over said frequency range.

In the lowest frequency domain the driving force coming from the actuator 4 drives the cone body 3 like a pure piston. Into the higher frequency range the acceleration of the driving force becomes so high that the total cone body 3 can no longer follow the accelerations of the actuator 4. As a result, a decrease in effective radiating surface of the cone body 3 and thus of the loudspeaker occurs. This effect is then leading to a decrease in the corresponding moving mass. Increasing the frequency even more will lead to a further decrease in the effective radiating surface, and eventually at very high frequencies the only part left radiating energy is the dust cap 9, which is conventionally placed on the actuator housing 7. This effect occurs in the known design. Making loudspeakers flatter aggravates the problem, i.e. the higher part of the working range is effected.

FIG. 2 shows an embodiment of the loudspeaker according to the invention in a diagrammatic cross-section.

The diaphragm 8 is not directly connected to the actuator housing 7, but a bridging element 10 extends, at a distance from the actuator housing, between the diaphragm 8 and the cone body 3, and is connected at contact areas situated around the actuator housing 7 to the cone body 3.

The bridging element has a positive effect on the reduction of effective mass and effective areas which occurs as the frequency increases. As a consequence the effective frequency range increases and the behavior over the frequency range is more constant. The effective areas does decrease as the frequency increases, but the decrease is slowed down, as the effective area start to approach the point of contact 10b, due to the mechanical bridge between the cone body and the diaphragm formed by the bridging element 10. As a consequence the effective frequency range is increased.

The effect of the contact areas at low frequencies should be relatively small. A complete contact ring between bridging element 10 and cone body 3 would stiffen the cone body considerably, even at lower frequencies. Therefore, the bridging element 10 is connected at a number of contact areas 10a around the actuator support 7.

Preferably the number of contact areas 10a is three to eight, more preferably 4 to 6, most preferably 4.

At low frequency the effect of the contact areas is preferably small, if at all present.

A higher number of contact areas (higher than 8) would provide a mechanical coupling between the cone body and the diaphragm which would have a considerable stiffening effect on the cone body also in the lower part of the frequency range.

Two contact areas would provide only a limited positive effect.

The distance D1 between the contact areas 10a and the actuator support 7 is preferably between ⅕ and ½ of the radial extent D2 of the cone body, more preferably between ⅕ and ⅖, most preferably between 0.25 and 0.35. The radial extent of the cone body is the extent of the cone body between the actuator support 7 and an outer suspension 6 of the cone body.

The effect of the bridging element is to begin to be noticeable at higher frequencies to improve the behavior of the loudspeaker at said higher frequencies. At lower frequencies, there is no need for the effect of the bridging element; in fact it is slightly detrimental. The further the contact points are from the actuator body, the lower the frequency is at which the effect of the bridging element becomes noticeable. The less the distance to the actuator support is, the less the effect at higher frequencies. In the indicated range, the positive effect is very noticeable and favorable, while the negative effect at lower frequency is small to negligible. Also on of the functions of the diaphragm is to guide the movable cone body 3 along the direction T. A too great a distance D1 would reduce this effect.

Preferably the bridging element 10 is a single piece connected via a ring 11 with the diaphragm. The bridging element 10 could be made of a number of sub-elements, each forming a connection between the cone body 3 and the diaphragm 8. However, it is preferred if the bridging element 10 is a single piece, having a ring-shaped part 11 for connection with the diaphragm. The ring-shaped part 11 provides stiffness to the diaphragm 8 at the contact points, reducing the possibility of the generation of vibrations in the diaphragm 8. Vibrations in the diaphragm would have a negative effect on the guiding function of the diaphragm.

FIG. 3 is a perspective elerational view of the loudspeaker of FIG. 2 in an exploded view.

FIG. 4 is a top view of the loudspeaker of FIG. 2.

FIG. 5 illustrates, in the form of a graph, the sound pressure level of a conventional loudspeaker (line 51a) expressed in dB, as a function of frequency (f) and the same of a loudspeaker in accordance with the invention (line 51b). Both loudspeakers have a diameter of 4 inch, have substantially similar mechanical stroke and substantially similar power requirements and power temperature. In both designs the sound pressure level remains substantially constant between 100 Hz and 10 kHz. The difference between the two designs is, however, that wherein in the conventional design the depth of the loudspeaker is 6 cm in this example, the comparable loudspeaker in accordance with the invention has a depth of 3.5 cm. Thus the invention enables a much flatter construction while yet substantially retaining the power and frequency response of the conventional design, thus providing a solution, at least for a greater part, for the dilemma identified in the opening part of the description.

It will be clear that within the framework of the invention many variations are possible. It will be appreciated by persons skilled in the art that the present invention is not limited by what has been particularly shown and described hereinabove. The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements.

For instance, the loudspeaker may have an oval or substantially rectangular shape. In such design it is advantageous to position the points of contact 10a symmetrically in respect of the axes of symmetry of the cone body. FIG. 6 illustrates an oval design.

1. Loudspeaker (1) provided with a chassis (2), a movable cone body (3), a resilient suspension for guiding the movable cone body (3) with respect to the chassis (2) along a translation axis (T), and an electric actuator (4) for driving the movable cone body (3) along the translation axis, and an actuator support (7) and a centering diaphragm (8), wherein the centering diaphragm (8) and the movable cone body (3) are interconnected, at a distance (D1) from the actuator support (7), by a bridging element (10), the bridging element (10) having a number of separate contact areas (10a) with the movable cone body (3) around the actuator support (7).

2. Loudspeaker as claimed in claim 1, wherein the number of contact areas is three to eight.

3. Loudspeaker as claimed in claim 2, wherein the number of contact areas is four to six.

4. Loudspeaker as claimed in claim 1, wherein the distance (D1) between the contact areas (10a) and the actuator support (7) is between ⅕ and ½ of the radial extent (D2) of the movable cone body (3).

5. Loudspeaker as claimed in claim 4, wherein the distance (D1) between the contact areas (10a) and the actuator support (7) is between ⅕ and ⅖ of the radial extent (D2) of the movable cone body (3).

6. Loudspeaker as claimed in claim 5, wherein the distance D1 between the contact areas (10a) and the actuator support (7) is between 0.25 and 0.35 of the radial extent (D2) of the movable cone body (3).

7. Loudspeaker as claimed in claim 1, wherein the bridging element (10) is a single part.

8. Loudspeaker as claimed in claim 7, wherein the bridging element (10) comprises a ring part (11) to which the diaphragm is connected.

9. Loudspeaker as claimed in claim 1, wherein the loudspeaker has a movable cone body having a number of symmetry axes, wherein the contact areas are symmetrically positioned in respect of the symmetry axes.
